(19) United States
(12) Patent Application Publication
(10) Pub. No.: US 2024/0424723 A1
(43) Pub. Date: Dec. 26, 2024

(54) A METHOD OF FORMING A CONTAINER

(71) Applicant: CREATIVE PROPACK LTD., Mumbai, Maharashtra (IN)

(72) Inventors: Ritesh AGARWAL, Mumbai, Maharashtra (IN); Hersh AGARWAL, Mumbai, Maharashtra (IN)

(21) Appl. No.: 18/262,897

(22) PCT Filed: May 27, 2021
(86) PCT No.: PCT/IN2021/050516

§ 371 Date: Jul. 25, 2023

(30) Foreign Application Priority Data
Jan. 30, 2021 (IN) 202121004171

(51) Int. Cl. B29C 49/00; B29C 33/42; B29C 49/06; B29K 23/00; B29K 105/26; B29L 31/00; B65D 1/02

(52) U.S. Cl. CPC B29C 49/071; B29C 33/42; B29C 49/06; B65D 1/0223; B29C 2949/0741; B29C 2949/081; B29K 2023/00; B29K 2105/26; B29L 2031/712; B65D 2501/0018

(57) ABSTRACT

A method of producing containers with at least one enhanced property, such as high strength, sturdy, durable, and recyclable are described herein. The container so formed have ribs/patterns at the inner surface, leaving the entire outer surface for decorative or marketing purposes. The ribs/pattern is selected from linear lines, curved lines, honeycombs, hexagons, square, rectangular, circular and combination thereof. The containers so formed may have reduced amount of materials used.

### FIELD OF INVENTION

The present invention relates to a method of forming containers. More particularly, the present invention relates to producing high strength, durable, recyclable plastic bottles, with potentially reduced amount of plastic, yet rendering sufficient strength and integrity to the structure.

### BACKGROUND & PRIOR ART

Normally, the strength of a plastic container, more particularly a bottle, is dependent on the amount of plastic used during the manufacturing process. To further improve the performance, plurality of ribs are added at the outer surface of the container. The ribs are outward projections at the surface of the container. Such ribs may be horizontal/circumferential or vertical. The ribs at the outer surface may also assist in gripping the bottle. The horizontal ribs do not sufficiently enhance the properties of the container, such as top load and compression strength. For such a problem, vertical ribs were an option, as demonstrated in U.S. Pat. No. 6,095,360.

However, major disadvantage of having the ribs at the outer surface of the container is the obstruction of the aesthetics of the container, such as efficient labelling on the container. Therefore, ribs inside the container were proposed. One such method is described in U.S. Pat. No. 4,892,205.

U.S. Pat. No. 4,892,205 relates to a preform for blow molding plastic containers having a self-supporting base structure. The preform has a reinforcing section of concentric annular ribs near its closed end. The wall thickness of the preform is increased in the reinforcing section by a plurality having an increasing thickness in a direction toward the closed end of the preform. The core rod is used to injection mold the preform. The core rod includes at its lower end a plurality of successively decreasing diameter portions which are used to mold a plurality of concentric annular reinforcing ribs in the inner wall of preform. The ribs are formed in axial direction and on base of bottle which does not provide as much stiffness as the vertical ribs. It also does not allow the reduction in the thickness of the container side wall, thus leading to wastage or use of excessive plastic. Further, the said method described in U.S. Pat. No. 4,892,205 causes inconsistent wall thickness of the container, which has significant impact on the quality of the container.

WO1993014916 discloses method and apparatus for injection molding and a hollow plastic article formed thereby with pressurized gas which provides for displacement by the gas of a portion of plastic from a channel of the mold cavity into a flow coupled spill cavity. The mold cavity includes a channel having a shape defining a rib portion of the article to be molded.

WO/2011/057036 relates to plastic preform for a container comprising at least one elongate reinforcing element provided on the inner side of the side wall which is obtained by injection-molding and the container having a continuous and smooth outer surface. The Preform is made from a thermoplastic material, wherein the thermoplastic is chosen from the group consisting of polyethylene terephthalates, polypropylenes, polyethylenes, polycarbonates, polystyrenes, polylactic acids, polyvinyl chlorides and combinations thereof. It is to be noted that the elongated reinforcing elements at the inner side take the shape of the elongations provided at the inner walls of the preform. Further, the invention described in said disclosure employs stretch moulding method, which is mainly applied for producing PET containers.

Usually, the plastic bottles are made according to blow molding method. In this method, the core rods do not contain any features and are predominantly smooth, whereas the features to be appeared on any of the walls of the bottle are effected by corresponding features in mould. The aforesaid prior arts describe these methods. The present invention proposes a method of producing a container that includes ribs at the inner side wall formed by engraving core rod. The containers so formed have structural integrity, high top loading and compression strength compared to the bottles produced by previously known methods.

### SUMMARY OF INVENTION

Accordingly, the present invention discloses a method of forming a container with enhanced properties such as excellent top loading and compression strength. Further, the container so formed may have reduced amount of plastic as against the typically containers of prior art. Furthermore, the container so formed is recyclable.

According to an aspect of the present invention, the method of forming a container comprises steps of: engraving plurality of ribs/pattern on a core rod creating a ribbed/patterned preform with ribs on the inner surface of preform in accordance with the ribs/pattern so engraved on the core rod; and blow molding the ribbed/patterned preform, thereby forming the container with ribs/pattern so engraved on the inside surface of the container.

The container formed according to the present method includes ribs at the inner side of the walls. The ribs/pattern is selected from linear lines, curved lines, honeycombs, hexagons, square, rectangular, and combination thereof.

In an embodiment, the preform is made of materials selected from High Density Poly Ethylene (HDPE), Low Density Poly Ethylene (LDPE), Linear Low Density Poly Ethylene (LLDPE), Polypropylene (PP), their blends and such.

In an embodiment, the preform can also be made from recycled material, thereby reducing carbon footprint, helps in environmental protection and at the same time produces a novel product with improved technical features.

The present invention further discloses a container possessing structural integrity, with enhanced properties such as excellent top loading and compression strength. Further, the container is recyclable.

The said container comprises a neck, a bottom, a body having an outer surface and an inner surface, wherein the inner surface is provided with plurality of ribs/pattern at the inner side, thereby rendering the container with enhanced properties. The ribs/pattern are vertical, and may further be selected from any of linear lines, curved lines, honeycombs, hexagons, square, rectangular, and combination thereof.

### BRIEF DESCRIPTION OF DRAWINGS

The figures below show an exemplary embodiment:

FIG. 1 illustrates a container formed from the method of the invention. In this exemplary embodiment, the container is a bottle. The ribs are seen inside the bottle.

FIG. 2 illustrates an inside view of the bottle, showing internal ribs.

FIG. 3 illustrates ribbed/patterned core rod, wherein the ribs/pattern are vertical (straight) lines.

FIG. 4 illustrates the process schematics.

FIG. 5a illustrates another embodiment, wherein the core rod is engraved with vertical wavy pattern.

FIG. 5b illustrates another embodiment, wherein the core rod is engraved with hexagonal pattern.

FIG. 5c illustrates yet another embodiment, wherein the core rod is engraved with horizontal lines.

FIG. 5d illustrates yet another embodiment, wherein the core rod is engraved with horizontal wavy lines.

FIG. 5e illustrates additional embodiment, wherein the core rod is engraved with circular pattern.

FIG. 5f illustrates additional embodiment, wherein the core rod is engraved with cross pattern.

### DESCRIPTION OF INVENTION

The present invention discloses a container and a method of forming a container having at least one of the enhanced properties such as excellent top loading and compression strength. Further, the container may have reduced amount of plastic, thereby reducing carbon footprint.

For practical purposes, the description of known components or manufacturing processes are omitted in the above description to avoid any ambiguity that may arise while referring to specification. Further, certain terms and conditions have their usual meaning known to the person skilled in the art.

The present invention is comprehended with reference to accompanying figures, which describe the best embodiment as well as alternate embodiments of the invention. However, it may be noted that the figures demonstrate different embodiments and are not intended to restrict the scope of the invention.

In a preferred embodiment of the present invention, the method of forming a container comprises steps of: engraving plurality of ribs/pattern on a core rod; creating a ribbed/patterned preform with ribs on the inner surface of preform in accordance with the ribs/pattern so engraved on the core rod; and blow molding the ribbed/patterned preform, thereby forming the container with ribs/pattern so engraved on the inside surface of the container.

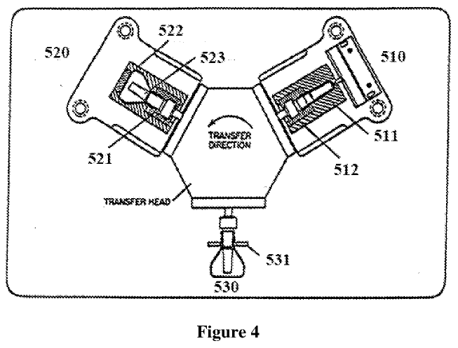

In the present method, the blow molding process is injection blow molding. FIG. 4 illustrates the process diagram in which preforms are made on the ribbed/patterned core rods in the first step with a neck ring 512. The core rods are rotated by 120 degree and blown using compressed air, holding necks in place. The core rods are rotated again by 120 degree, thereby ejecting the container. This process gives precise neck finish. Addition of ribs using this invention provides excellent strength and integrity to the container.

In a preferred embodiment, the injection moulding temperature is between 130-300 deg. C. However, the best results are obtained, when the moulding temperature is between 180-250 deg. C. The preferred method has the blow air pressure is between 3-14 bar. However, the best method utilizes the blow air pressure is between 7-10 bar.

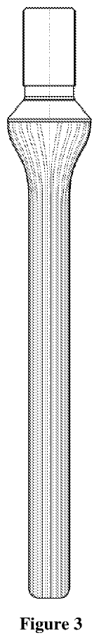

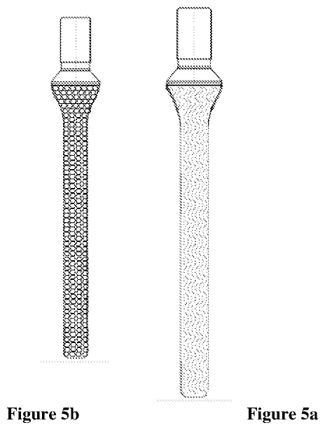

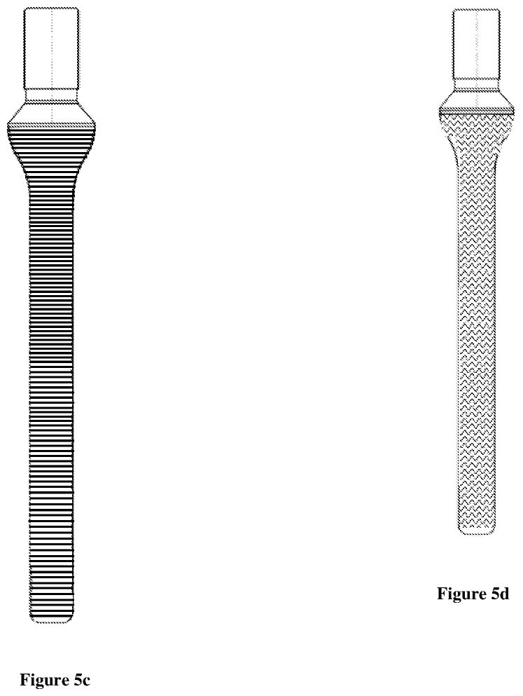

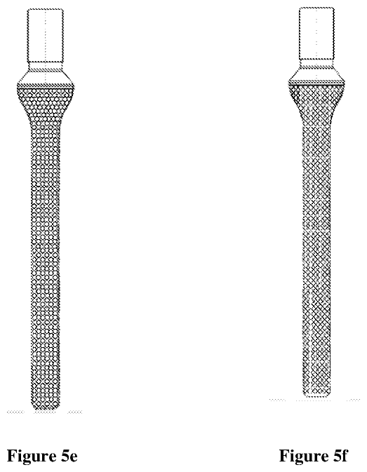

In a preferred embodiment, the ribs/pattern engraved on the core rod are vertical in nature. However, ribs/pattern is selected from linear lines, curved lines, honeycombs, hexagons, square, rectangular, circular and combination thereof. FIG. 3 demonstrates the core rod with vertical straight lines engraved on it, whereas FIG. 5a demonstrates vertical wavy lines engraved on the core rod. FIG. 5b illustrates the core rod with hexagonal ribs/pattern. FIG. 5c illustrates yet another embodiment, wherein the core rod is engraved with horizontal lines. FIG. 5d illustrates yet another embodiment, wherein the core rod is engraved with horizontal wavy lines. FIG. 5e illustrates additional embodiment, wherein the core rod is engraved with circular pattern. FIG. 5f illustrates additional embodiment, wherein the core rod is engraved with cross pattern. It may be noted that the ribs/pattern on the inner walls correspond to the ribs/pattern engraved on the core rods.

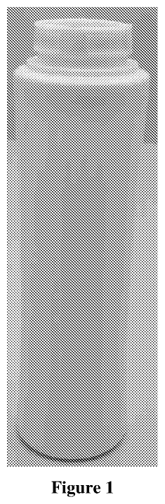

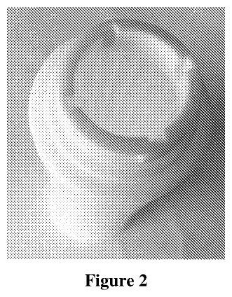

FIG. 1 and FIG. 2 illustrate the container with vertical straight lines at the inner surface, produced with the method described. FIG. 1 and FIG. 2 depict the most preferred embodiment of the invention. The present inventors, through experiments, have found that the performance of the container depends upon the number of ribs, dimensions of the ribs, and shape of the ribs/or pattern formed on the core rod.

It may be noted that any number of ribs may be added on the core rod. In a preferred embodiment, a number of said ribs/patterns ranges from 2 to 96. In a most preferred embodiment, number of said ribs/patterns ranges from 16 to 48.

In a preferred embodiment, the ribs/pattern have width ranging from 0.1 mm to 1 mm. In the same embodiment, ribs/pattern have depth of 0.1 mm to 10 mm.

In a preferred embodiment, the distance between ribs/patterns is from 0.1 mm to 100 mm, depending upon the size of the container. However in a most preferred embodiment, the distance between ribs/patterns is from 0.2 mm to 5 mm.

In a preferred embodiment, the said ribs are provided at an angle from 0 degree to 45 degree to a vertical axis. In the best embodiment, the said ribs are provided at an angle from 10 degree to 25 degree.

The preform is made of materials selected from High Density Poly Ethylene (HDPE), Low Density Poly Ethylene (LDPE), Linear Low Density Poly Ethylene (LLDPE), Polypropylene (PP), their blends and such, which may be virgin or recyclable material.

The present invention further discloses a container which comprises a neck, a bottom, a body having an outer surface and an inner surface, wherein the inner surface is provided with plurality of ribs/pattern at the inner side, thereby rendering the container with enhanced properties. Preferably, the ribs are vertical in nature. Further, ribs/pattern is selected from linear lines, curved lines, honeycombs, hexagons, square, rectangular, circular and combination thereof.

The container formed by the method disclosed may include recycled resin, in a proportion from 0-100%. This provides potential Sustainability benefits and reduces carbon foot-print and Green House Gas (GHG) emission.

Further, the container formed from the present method can be easily recycled. The container does not require extra quantity of material, thereby helping in reducing environmentally hazardous non-degradable waste.

The container formed from the present method has its weight reduced from 0% to 40%. Yet, the container has excellent top load, compression strength and hoop strength. Further, the addition of ribs inside the walls of the container prevents the container from being deformed, or dented easily during shipping & distribution and decoration such as shrink sleeving or labelling. The addition of ribs inside the bottle do not interfere with decorative process including labelling, shrink sleeving and printing on the outer surface of the container. The ribs can be added on the entire inner surface of the container without affecting decorative process.

The container formed according to the present method with vertical ribs has 0-60% higher top load than the containers without ribs at the same weight. The present method is capable of producing the container having any given volume. Preferably, the container has volume that falls between wide range, typically between 5 cc to 3000 ml.

The method of the invention may be employed for manufacturing containers which can be used for a multitude of applications e.g. Pharmaceuticals, Personal Care, Home Care, Oils, Lubricants, Pesticides, Foods, and such.

The advantages of the present invention is demonstrated herein with assistance of the examples. It may be noted that the examples described herein are not intended to restrict the scope of the invention.

### Example 1

The data presented in this Example demonstrates increased top load strength as compared to state of the art container, even when the weight of the present container is significantly less than that of known container. The volume was kept the same.

| | | | Top Load | Process | Process |
|---|---|---|---|---|---|
| | Volume | Weight | Strength | Temp | Pressure |
| | (ml) | (g) | (N) | (C.) | (bar) |
| State of art | 30 | 6.5 | 250 | 220 | 8 |
| Present | 30 | 5.8 | 275 | 220 | 8 |
| Invention - | | | | | |
| sample 1 | | | | | |
| Present | 30 | 6.5 | 425 | 220 | 8 |
| Invention - | | | | | |
| sample 2 | | | | | |

The said example demonstrates the increased top load strength for the containers of small volumes.

### Example 2

The data presented in this Example demonstrates increased top load strength as compared to state of the art container, even when the weight of the present container is significantly less than that of known container. The volume was kept the same.

| | | | Top Load | Process | Process |
|---|---|---|---|---|---|
| | Volume | Weight | Strength | Temp | Pressure |
| | (ml) | (g) | (N) | (C.) | (bar) |
| State of art | 600 | 45 | 350 | 235 | 8.5 |
| Present | 600 | 40.5 | 355 | 235 | 8.5 |
| Invention | | | | | |
| Invention 2- | 600 | 45 | 550 | 235 | 8.5 |
| stronger | | | | | |

The said example demonstrates increased top load strength for the containers of larger volume, produced by the method described in this specification.

From the data provided in the aforesaid examples, it may be concluded that the containers, having various sizes and volumes, prepared by the method described in the present invention have at least one enhanced characteristic. Such characteristics include top loading and compression strength, sturdiness, durable, and recyclable. Therefore, the container so produced from the method of the instant invention may have higher top load with same weight as that of the state of the art containers. Further, the container may have same top loading but reduced weight as that of the state of the art container. Further, the containers produced by the method described in this specification are recyclable. Furthermore, the containers produced by the method described in this specification may have reduced amount of materials used. It has been also demonstrated in the examples that such enhanced properties are rendered to the container, even if the container is light weighted, by the use of the method described in the invention.

The present invention has wide range of applicability. The said invention is suitable in manufacturing of FMCG, personal care, home care, pharma and food industry. However, the aforementioned areas are only for exemplary purpose. The present invention may be applicable in innumerable areas where plastic containers are used.

The above description is merely illustrative, which is not intended to limit the scope of the invention to the described embodiment. The description covers alternatives, modifications of the embodiments described above. Number of alternatives, modification, changes, integration in terms of material used and method employed may be envisaged within the scope of the invention. The various features and advantages above are demonstrated with reference to the various embodiments in accordance with the present invention.

We claim:

1. A method of forming a container having ribs at an inner surface thereby providing the container with at least one enhanced property comprising steps of:
(a) engraving plurality of ribs/pattern on a core rod;
(b) creating a ribbed/patterned preform with ribs on the inner surface of preform in accordance with the ribs/pattern so engraved on the core rod; and
(c) blow molding the ribbed/patterned preform, thereby forming the container with ribs/pattern so engraved on the inside surface of the container.

2. The method as claimed in claim 1, wherein said ribs/pattern is selected from linear lines, curved lines, honeycombs, hexagons, square, rectangular, circular and combination thereof.

3. The method as claimed in claim 1, wherein ribs/pattern have width of 0.1 mm to 10 mm.

4. The method as claimed in claim 1, wherein ribs/pattern have depth of 0.1 mm to 10 mm.

5. The method as claimed in claim 1, wherein the distance between ribs/patterns is from 0.1 mm to 100 mm depending upon the size of the container.

6. The method as claimed in claim 5, wherein the distance between ribs/patterns is from 0.2 mm to 5 mm.

7. The method as claimed in claim 1, wherein a number of said ribs/patterns ranges from 2 to 96.

8. The method as claimed in claim 7, wherein a number of said ribs/patterns ranges from 16 to 48.

9. The method as claimed in claim 1, wherein the said ribs are provided at an angle from 0 degree to 45 degree to a vertical axis.

10. The method as claimed in claim 9, wherein the said ribs are provided at an angle from 10 degree to 25 degree.

11. The method as claimed in claim 1, wherein the preform is made of materials selected from High Density Poly Ethylene (HDPE), Low Density Poly Ethylene (LDPE), Linear Low Density Poly Ethylene (LLDPE), Polypropylene (PP), their blends and such.

12. The method as claimed in claim 1, wherein injection moulding temperature is between 130-300 deg. C.

13. The method as claimed in claim 12, wherein injection moulding temperature is between 180-250 deg. C.

14. The method as claimed in claim 1, wherein the blow air pressure is between 3-14 bar.

15. The method as claimed in claim 14, wherein the blow air pressure is between 7-10 bar.

16. The method as claimed in claim 1, wherein the container includes recycled resin from 0-100%.

17. A container comprises a neck, a bottom, a body having an outer surface and an inner surface, wherein the inner surface is provided with plurality of ribs/pattern, thereby rendering the container with enhanced properties.

18. The container as claimed in claim 17, wherein said ribs/pattern is selected from linear lines, curved lines, honeycombs, hexagons, square, rectangular, circular and combination thereof.

19. The method as claimed in claim 1, wherein container size is from 5 cc to 3,000 ml.
